(19) United States
(12) Patent Application Publication
(10) Pub. No.: US 2011/0145060 A1
(43) Pub. Date: Jun. 16, 2011

(54) BROADCASTING METHOD OF ADVERTISEMENT

(76) Inventors: Byoung Hoon Lee, Gyeonggi-do (KR); Sung Hwa Lim, Gyeonggi-do (KR); Jai Hoon Kim, Gyeonggi-do (KR); We Duke Cho, Gyeonggi-do (KR)

(21) Appl. No.: 13/055,202

(22) PCT Filed: Sep. 19, 2008
(86) PCT No.: PCT/KR2008/005533

§ 371 Date: Feb. 18, 2011

(30) Foreign Application Priority Data
Jul. 24, 2008 (KR) 1020080072129

(51) Int. Cl. G06Q 30/00

(52) U.S. Cl. 705/14.48; 705/14.73

(57) ABSTRACT

There is provided a method of broadcasting advertisements comprising calculating online scheduling values in proportion to preferences of users in each area of advertisement display devices for advertisement items; calculating a standard deviation between the online scheduling values of the advertisement display devices; selecting an advertisement item having a maximum standard deviation; selecting an advertisement display device having a maximum online scheduling value; transmitting the selected advertisement item to the selected advertisement display device; and excluding advertisement display devices for the selected advertisement item and advertisement items for the selected advertisement display device.

### TECHNICAL FIELD

The present invention relates to a method of broadcasting advertisements, and more particularly, to a method of broadcasting advertisements impartially transmitting advertisement items to a plurality of advertisement display devices simultaneously with adaptively providing the advertisement items according to relative preferences of the advertisement display devices.

### BACKGROUND ART

As a data broadcasting method to reduce average standby time and energy consumption, there are used longest wait first (LWF) and absolute validity interval (AVI) techniques. The LWF algorithm is used to reduce user response time. The AVI technique is a data item selection method to reduce a delay time to access data items.

### DETAILED DESCRIPTION OF THE INVENTION

### Technical Problem

The present invention provides a method of broadcasting advertisements, which is capable of impartially transmitting advertisement items to a plurality of advertisement display devices simultaneously with adaptively providing advertisement items according to relative preferences of the advertisement display devices.

### Technical Solution

According to an aspect of the present invention, there is provided a method of broadcasting advertisements, the method including: calculating online scheduling values in proportion to preferences of users in each area of advertisement display devices for advertisement items, with respect to the advertisement items, to be processed in a present time slot, and the advertisement display devices; calculating a standard deviation between the online scheduling values of the advertisement display devices, with respect to each of the advertisement items; selecting an advertisement item having a maximum standard deviation; selecting an advertisement display device having a maximum online scheduling value with respect to the selected advertisement item; transmitting the selected advertisement item to the selected advertisement display device; and excluding advertisement display devices for the selected advertisement item and advertisement items for the selected advertisement display device. When there are left advertisement items and advertisement display devices to be processed after the excluding, the selecting an advertisement item having a maximum standard deviation is performed again with respect to the left advertisement items and advertisement display devices. The online scheduling value may be in proportion to a cost of the advertisement item.

### Advantageous Effects

A method of broadcasting advertisements according to an embodiment of the present invention may reduce a time for waiting a desired advertisement item according to preferences of a user within the range of impartially transmitting advertisement items equally provided.

### BRIEF DESCRIPTION OF THE DRAWINGS

FIG. 1 is a concept view illustrating a method of broadcasting advertisements according to an embodiment of the present invention; and

FIG. 2 is a flowchart illustrating the method of broadcasting advertisements.

### BEST MODE FOR CARRYING OUT THE INVENTION

To fully understand advantages of operations of the present invention and the objects obtained by embodiments of the present invention, it is required to refer to attached drawings illustrating preferable embodiments of the present invention and contents shown in the drawings. Hereinafter, the preferable embodiments of the present invention will be described in detail with reference to the attached drawings. The same reference numerals shown in each drawing indicate the same elements.

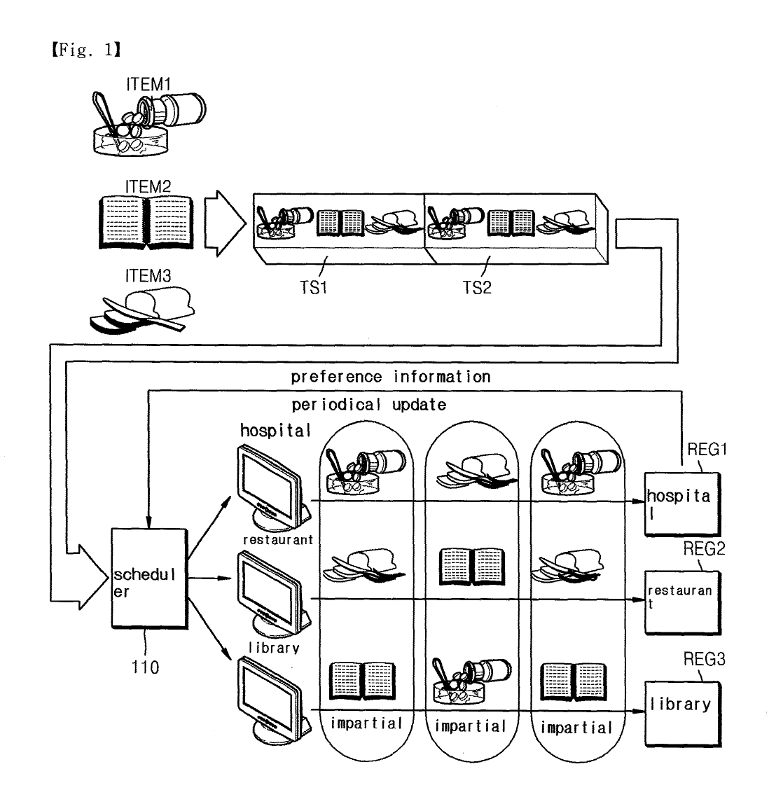

FIG. 1 is a concept view illustrating a method of broadcasting advertisements according to an embodiment of the present invention. In ubiquitous environments, information providers transmit information to a plurality of clients and service devices such as advertisement display devices in a wide area. The method of broadcasting advertisements may allow advertisement items to be equally transmitted to a plurality of advertisement display devices simultaneously with being adaptively provided according to relative preferences of the advertisement display devices.

Referring to FIG. 1, the method of broadcasting advertisements may allow advertisement items advertising medicines, breads, and books to be transmitted to advertisement display devices installed in hospitals, restaurants, and libraries, respectively.

In this case, according to the method of broadcasting advertisements, advertisement items related to medicine may be frequently transmitted to an advertisement display device installed in a hospital, advertisement items related to bread may be frequently transmitted to an advertisement display device installed in a restaurant, and advertisement items related to book may be frequently transmitted to an advertisement display device installed in a library, while transmitting the same number of advertisement items in the same time slot.

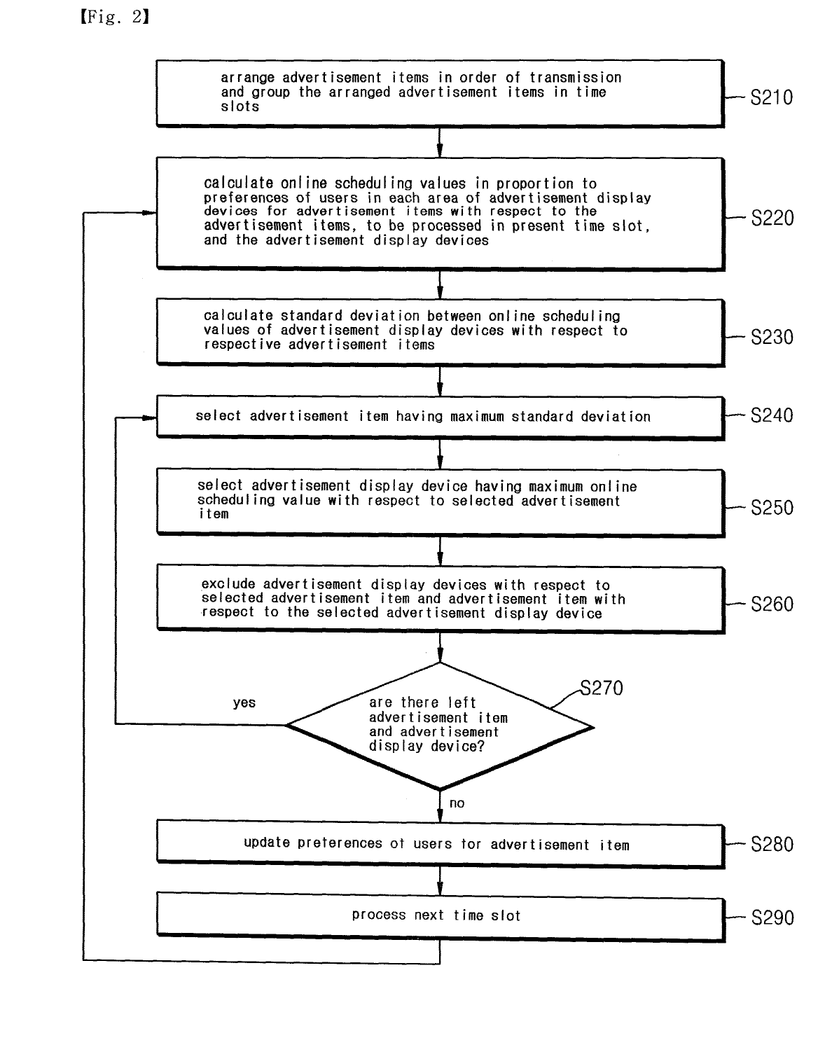

FIG. 2 is a flowchart illustrating the method of broadcasting advertisements. Hereinafter, it is assumed that there are five advertisement items A, B, C, D, and E and five advertisement display devices M1, M2, M3, M4, and M5. With respect to advertisement items and advertisement display devices, which are to be processed in a first time slot, there are calculated online scheduling values in proportion to preferences of users for advertisement items in the advertisement display devices, respectively (S220). The online scheduling value F(i) may be calculated as

F(i)=[Q−R(i)]²*[P(i)/L(i)] Equation (1)

wherein Q indicates a present time, R(i) indicates a time of most recently transmitting an ith advertisement item, P(i) indicates preferences of users for the ith advertisement item, and L(i) indicates the data size of the ith advertisement item.

In the first time slot, since advertisement items are not yet transmitted, values of [Q−R(i)] with respect to all advertisement items are the same. Also, when assuming that the data sizes of the advertisement items are all the same, the value of L(i) of all advertisement items are the same. In this case, the online scheduling value F(i) is identical to preferences of users for each of the advertisement items A, B, C, D, and E.

In Table 1, there are shown the online scheduling values, that is, preferences of users, with respect to the respective advertisement items A, B, C, D, and E and the advertisement display devices M1, M2, M3, M4, and M5. For example, the online scheduling value of the advertisement item A and the advertisement display device M1 indicates an online scheduling value P[A, M1] that is calculated based on preferences of a user in the area of the advertisement display device M1 for the advertisement item A.

TABLE 1

| | A | B | C | D | E |
|---|---|---|---|---|---|
| M1 | 8 | 5 | 3 | 30 | 15 |
| M2 | 9 | 12 | 15 | 25 | 5 |
| M3 | 7 | 3 | 1 | 20 | 13 |
| M4 | 10 | 3 | 5 | 16 | 30 |
| M5 | 8 | 15 | 30 | 5 | 20 |
| Standard | 2.28 | 11 | 24 | 19 | 18 |
| Deviation | | | | | |

Next, standard deviations between the online scheduling values of the advertisement display devices M1, M2, M3, M4, and M5 with respect to the respective advertisement items A, B, C, D, and E are calculated (S230). The calculated standard deviations are shown in Table 1. The standard deviation of the advertisement item C is greatest (S240), and the advertisement display device M5 has a maximum online scheduling value with respect to the advertisement item C (S250). Accordingly, in the first time slot, the advertisement item C is determined to be transmitted to the advertisement display device M5. Next, the advertisement item C and the advertisement display device M5, which are determined, are removed form Table 1 (S260). A result of the removing is shown in Table 2. The described operations are repeatedly performed with respect to the left advertisement items A, B, D, and E and the advertisement display devices M1, M2, M3, and M4 (S240, S250, and S260).

TABLE 2

| | A | B | D | E |
|---|---|---|---|---|
| M1 | 8 | 5 | 30 | 15 |
| M2 | 9 | 12 | 25 | 5 |
| M3 | 7 | 3 | 20 | 13 |
| M4 | 10 | 3 | 16 | 30 |
| Standard | 2.28 | 11 | 19 | 18 |
| Deviation | | | | |

Referring to Table 2, the standard deviation of the advertisement item D is greatest (S240), and the advertisement display device M1 has a maximum online scheduling value with respect to the advertisement item D (S250). Accordingly, in the first time slot, the advertisement item D is determined to be transmitted to the advertisement display device M1.

Next, the advertisement item D and the advertisement display device M1, which are determined, are removed from Table 2 (S260). A result of the removing is shown in Table 3.

TABLE 3

| | A | B | E |
|---|---|---|---|
| M2 | 9 | 12 | 5 |
| M3 | 7 | 3 | 13 |
| M4 | 10 | 3 | 30 |
| Standard | 2.28 | 11 | 18 |
| Deviation | | | |

Through such process, there are determined the advertisement display devices M1, M2, M3, M4, and M5 where the advertisement items A, B, C, D, and E are to be transmitted in the first time slot (refer to Table 4). According to a result shown in Table 4, the advertisement items A, B, C, D, and E are transmitted to the advertisement display devices M1, M2, M3, M4, and M5.

TABLE 4

| | Time Slot | | |
|---|---|---|---|
| | 1 | 2 | 3 |
| M1 | D | | |
| M2 | B | | |
| M3 | A | | |
| M4 | E | | |
| M5 | C | | |

When the process of the first time slot is finished, a process of determining the advertisement display devices M1, M2, M3, M4, and M5 where the advertisement items A, B, C, D, and E are to be transmitted in a second time is performed (S290). Before starting the process of the second time slot, preferences of users for the advertisement items A, B, C, ID, and E may be updated (S280). In this case, the process of the second time slot is performed based on the updated preferences of users. The preferences of users may be shown as statistics according to tastes of a plurality of persons for a long time. In this case, the preferences of users may vary with the passage of time. When the preferences of users vary, an advertisement display device may update user preference information. According to the updated user preference information, an advertisement item may be transmitted with higher frequency to an advertisement display device where requirements of users for transmission are high.

The process of the second time slot is similar to that of the first time slot. Only, in Equation 1, since the advertisement items are not yet transmitted in the first time slot, the values of [Q−R(i)] of all advertisement items are the same. However, the values of [Q−R(i)] of all advertisement items are not the same in the second time slot. Accordingly, in the second time slot, there are obtained online scheduling values including the value of [Q−R(i)]. Since a process after obtaining the online scheduling values is similar to that described in the process of the first time slot, a detailed description thereof will be omitted.

In the above, the case where the number of advertisement items is identical to that of advertisement display devices has been described. Next, there will be described a case where the number of advertisement items is greater than that of advertisement display devices. It is assumed that there are four advertisement items A, B, C, and D and three advertisement display devices M1, M2, and M3. First, the advertisement items A, B, C, and D are arranged by a specific way such as a round robin method, and the arranged advertisement items A, B, C, and D are grouped by time slots (S210). For example, the advertisements items A, B, C, and D are arranged in an order of A, B, C, D, A, B, C, and D and grouped into [A, B, and C in a first time slot], [D, A, and B in a second time slot], and [C, D, and A in a third time slot]. Next, there are calculated online scheduling values and standard deviations with respect to the advertisement items A, B, and C, to be transmitted in the first time slot, and the advertisement display devices M1, M2, and M3 (refer to Table 5).

TABLE 5

| | A | B | C |
|---|---|---|---|
| M1 | 8 | 5 | 3 |
| M2 | 9 | 12 | 15 |
| M3 | 7 | 3 | 1 |
| Standard | 1.4 | 6.7 | 7.1 |
| Deviation | | | |

Next, through a process similar to the described above, there are determined the advertisement display devices M1, M2, and M3 where the advertisement items A, B, and C are to be transmitted. When the process of the first time slot is finished as described above, there are determined the advertisement display devices M1, M2, and M3 where the advertisement items D, A, and B, to be transmitted in the second time slot, are to be transmitted. There will be described a case where the number of advertisement items is smaller than that of advertisement display devices. It is assumed that there are three advertisement items A, B, and C and four advertisement display devices M1, M2, and M3.

First, the advertisement items A, B, and C are arranged in a specific way such as the round robin method and grouped in time slots (S210). For example, the advertisements items A, B, C, and D are arranged in an order of A, B, C, A, B, and C and grouped into [A, B, C, and A in a first time slot] and [B, C, A and B in a second time slot]. Next, there are calculated online scheduling values and standard deviations with respect to the advertisement items A, B, C, and A, to be transmitted in the first time slot, and the advertisement display devices M1, M2, M3, and M4 (S220 and S230, refer to Table 6).

TABLE 6

| | A | B | C |
|---|---|---|---|
| M1 | 8 | 5 | 3 |
| M2 | 9 | 12 | 15 |
| M3 | 7 | 3 | 1 |
| M4 | 10 | 3 | 5 |
| Standard | 2.2 | 7.4 | 10.7 |
| Deviation | | | |

Referring to Table 6, a standard deviation of the advertisement item C is greatest (S240), and the advertisement display device M2 has a maximum online scheduling value with respect to the advertisement item C (S250). Accordingly, in the first time slot, the advertisement item C is determined to be transmitted to the advertisement display device M2.

Next, the advertisement item C, determined to be transmitted, and the advertisement display device M2 are removed from Table 6 (S260). The described operations are performed with respect to the left advertisement items A, B, and A and the advertisement display devices M1, M3, and M4 (S240, S250, and S260). As a result thereof, when the advertisement item B is determined to be transmitted to the advertisement display device Mt the advertisement items A and A are transmitted to the advertisement display devices M3 and M4. Next, there are calculated online scheduling values and standard deviations with respect to the advertisement items B, C, A, and B, to be transmitted in the second time slot, and the advertisement display devices M1, M2, M3, and M4.

In this case, it is assumed that the advertisement item B is transmitted to the advertisement display device M2, then the advertisement item A is transmitted to the advertisement display device M1. When the advertisement display device M4 has a maximum online scheduling value with respect to the left advertisement item C, the advertisement item C is transmitted to the advertisement display device M4. Finally, since the advertisement item B has to be transmitted once again, the advertisement item B is transmitted to the advertisement display device M3. On the other hand, when costs of respective advertisement items are different from one another, an advertisement item with a higher cost may be more frequently transmitted. That is, as shown in Equation 2, online scheduling values may be determined in proportion to costs of advertisement items.

F(i)=[Q−R(i)]²*[C(i)*P(i)/L(i)] Equation (2)

wherein C(i) indicates a cost of an advertisement item.

Advertisement display devices where advertisement items are transmitted may be determined using online scheduling values where costs of advertisement items are reflected. Since such process is similar to the process described before, a detailed description thereof will be omitted.

As described above, exemplary embodiments have been shown and described. Though specific terms are used herein, they are just used for describing the present invention but do not limit the meanings and the scope of the present invention disclosed in the claims. Therefore, it would be appreciated by those skilled in the art that changes may be made to these embodiments without departing from the principles and spirit of the invention. Accordingly, the technical scope of the present invention is defined by the claims and their equivalents.

### INDUSTRIAL APPLICABILITY

The present invention may be applied to the field of advertising techniques for pertinently distributing advertisements to advertisement display devices.

1. A method of broadcasting advertisements, the method comprising:
calculating online scheduling values in proportion to preferences of users in each area of advertisement display devices for advertisement items, with respect to the advertisement items, to be processed in a present time slot, and the advertisement display devices;
calculating a standard deviation between the online scheduling values of the advertisement display devices, with respect to each of the advertisement items;
selecting an advertisement item having a maximum standard deviation;
selecting an advertisement display device having a maximum online scheduling value with respect to the selected advertisement item;
transmitting the selected advertisement item to the selected advertisement display device; and
excluding an advertisement display device for the selected advertisement item and an advertisement item for the selected advertisement display device,
wherein, when there are a remaining advertisement item and a remaining advertisement display device to be processed after the excluding, the selecting an advertisement item having a maximum standard deviation is performed again with respect to the remaining advertisement item and the remaining advertisement display device.

2. The method of claim 1, wherein the online scheduling value is in proportion to a standby time indicating a time passing after most recently transmitting the advertisement item to the advertisement display device.

3. The method of claim 1, wherein the online scheduling value is in proportion to a cost of the advertisement item.

4. The method according to claim 1, wherein the online scheduling value is in inverse proportion to a size of the advertisement item.

5. The method of claim 1, further comprising, before the described operations:
arranging the advertisement items according to a transmission order; and
grouping the arranged advertisement items in time slots.

6. The method of claim 1, wherein, with respect to time slots next to the present time slot, the described operations are repeatedly performed.

7. The method of claim 6, further comprising, before repeatedly performing the operations, updating the preferences of users for advertisement items.

8. The method of claim 2, wherein the online scheduling value is in proportion to a cost of the advertisement item.

9. The method according to claim 2, wherein the online scheduling value is in inverse proportion to a size of the advertisement item.

10. The method according to claim 8, wherein the online scheduling value is in inverse proportion to a size of the advertisement item.
